(19) United States
(12) Patent Application Publication
(10) Pub. No.: US 2003/0097997 A1
(43) Pub. Date: May 29, 2003

(54) Kit and method for converting a diesel engine to natural gas engine

(76) Inventors: Robert Albert Lynch, (US); James Burkhart, (US)

Correspondence Address: Amy Natasha Slivocka, Suite 3000, 1717 Main Street, Dallas, TX, 75201, US

(21) Appl. No.: 10/273,964

(22) Filed: Oct. 19, 2002

Related U.S. Application Data
(60) Provisional application No. 60/343,853, filed on Oct. 19, 2001.
(60) Provisional application No. 60/343,925, filed on Oct. 19, 2001.
(60) Provisional application No. 60/343,930, filed on Oct. 19, 2001.
(60) Provisional application No. 60/343,931, filed on Oct. 19, 2001.
(60) Provisional application No. 60/343,933, filed on Oct. 19, 2001.

(51) Int. Cl. F02M 21/02

(52) U.S. Cl. 123/27 GE; 123/526

(57) ABSTRACT

A kit and method for converting a compression ignition diesel engine into a spark ignition natural gas engine is disclosed. The kit includes a throttle body, a fuel management system, a timing module, a means for reducing a compression ratio of a piston in the diesel engine, and a means for providing a spark in a cylinder of the natural gas engine. The method includes the steps of providing a diesel engine, machining one or more cylinder heads on the diesel engine to accept one or more spark plugs, machining a top surface of one or more pistons of the diesel engine to increase the volume of the one or more combustion chambers when the one or more pistons are located at top dead center in the diesel engine, providing a fuel management system to deliver the air/fuel mixture to the one or more combustion chambers, and providing a timing module to monitor the position of one or more camshafts on the diesel engine and provide piston position information to the fuel management system.

### RELATED APPLICATIONS

This application claims priority under 35 U.S.C. § 119(e)(1) to U.S. Provisional Application No. 60/343,853 filed on Oct. 19, 2001, U.S. Provisional Application No. 60/343,925 filed on Oct. 19, 2001, U.S. Provisional Application No. 60/343,930 filed on Oct. 19, 2001, U.S. Provisional Application No. 60/343,931 filed on Oct. 19, 2001, and U.S. Provisional Application No. 60/343,933 filed on Oct. 19, 2001.

### TECHNICAL FIELD OF THE INVENTION

The present invention relates to a novel kit and method for converting fuel injected diesel engine, which rely on the spontaneous ignition of a proper amount of diesel fuel and oxygen by simple compression, to the use of natural gas (either Compressed or Liquid), or a similar gaseous fuel in spark ignition engines, and in particular to the use of such gaseous fuels in engines and designed for vehicular applications. Such a kit and method provide control over the combustion process resulting in an engine with reduced pollutant levels.

### BACKGROUND OF THE INVENTION

For decades, fuel-efficient and mechanically simple diesel engines have powered motor vehicles and machines around the world. This current use of diesel fuel, used to power various forms of internal combustion engines, in particular those incorporated within motor vehicles, has a number of serious shortcomings in view of dwindling fossil fuel resources and the increasing awareness of the detrimental effects of pollution.

The desire to enjoy abundant energy while striving for the benefits of clean air has been evidenced by a push towards the use of natural gas vehicles, whose advantages are well recognized throughout the automotive industry. Natural gas is a widely distributed form of gaseous hydrocarbon fuel that typically comprises methane, although proportions of ethane, propane, and butane may also be present. Natural gas is a relatively clean burning fuel that produces fewer harmful tailpipe emissions than gasoline or diesel fuel. It is also known for its high octane, anti-knock characteristics that allow it to operate effectively without the use of hazardous additives. As a result, many companies that require maximum people and cargo hauling capability (such as airport shuttle operations) already use natural gas powered fleet vehicles. Like other alternate fuel vehicles, natural gas vehicles produce fewer emissions than traditional vehicles—as much as one-fifth to one-half of their gasoline fueled counterparts.

Advances have been made in developing components, systems and engines rendering engines capable of utilizing natural gas rather than diesel fuel and/or to solve the problems that many diesel engine components hold. But, despite recent developments, several components originally designed for diesel engines need adjustments and the conversion process, from a diesel engine to a natural gas engine is complex, inefficient and expensive.

An example of a diesel engine component needing adjustment is the piston for the typical modem day diesel engine, having three rings positioned in respective circumferential grooves proximate the closed (domed) end of the piston. A piston ring is fitted in each piston ring groove. Such an arrangement is commonly called a “three ring set” or a “three-ring pack.” This “three ring set” arrangement, however, allows undesirable amounts of oil into the combustion chamber, impairing engine performance and contaminating engine exhaust. In order to reduce exhaust emission, therefore, alterations to this component are needed.

It is a principal object of the present invention to provide an efficient and economical kit and method for the conversion of a diesel engine to allow it to operate on alternative gaseous fuels resulting in an engine with the same diesel engine performance but minimizing or eliminating emissions.

### BRIEF SUMMARY OF THE INVENTION

In accordance with the object of the invention, a brief summary of the present invention is presented. Some simplifications and omissions may be made in the following summary, which is intended to highlight and introduce some aspects of the present invention, but not to limit its scope. Detailed descriptions of a preferred embodiment adequate to allow those of ordinary skill in the art to make and use the inventive concepts will follow in later sections.

According to a broad aspect of the invention, a kit and method for converting a compression ignition diesel engine into a spark ignition natural gas engine is disclosed. The kit includes a throttle body, a fuel management system, a timing module, a means for reducing a compression ratio of a piston in the diesel engine, and a means for providing a spark in a cylinder of the natural gas engine.

The method includes the steps of providing a diesel engine, machining one or more cylinder heads on the diesel engine to accept one or more spark plugs, machining a top surface of one or more pistons of the diesel engine to increase the volume of the one or more combustion chambers when the one or more pistons are located at top dead center (TDC) in the diesel engine, providing a fuel management system to deliver the air/fuel mixture to the one or more combustion chambers, and providing a timing module to monitor the position of one or more camshafts on the diesel engine and provide piston position information to the fuel management system.

Moreover, the present invention solves the problem of the excess oil problems described above related to the typical diesel engine pistons. This need is met by adding a top scraper ring to the typical diesel engine piston assembly described above, wherein the scraper ring has a reverse keystone angle on the bottom of the ring. In accordance with one aspect of the present invention, a piston ring assembly comprises a piston ring positioned in a piston groove, and having a bottom front extending downwardly along a bottom side of the piston groove and toward a cylinder wall at an angle, with respect to a horizontal to form a “reverse keystone” bottom side angle, and further having a top surface extending inwardly along a top side of the piston groove.

The scraper ring minimizes the oil consumption of the piston engine because the reverse keystone bottom side angle produces concentrated and high seal pressure around the bottom side of the ring and the ring face as the piston moves downward. On the upstroke, the ring face tends to slide over the oil film rather than scrape oil toward the combustion chamber. An advantage of the concentrated and high seal pressure is that it reduces the amount of oil allowed to pass both behind the piston ring and along the ring face, thereby reducing oil consumption and emissions.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 is a side view of a converted engine according to one embodiment of the present invention;

FIG. 2 is a side view of a converted engine according to one embodiment of the present invention;

FIG. 3 is a schematic illustrating several modifications to a typical diesel engine that are performed to convert the diesel engine to efficiently operate on natural gas fuels, according to one embodiment of the present invention;

FIG. 4 is a side plane view of a piston according to one embodiment of the present invention;

FIG. 5 is a aerial perspective of the top surface of the piston according to one embodiment of the present invention;

FIG. 6 is an exploded view of the piston and its corresponding piston rings according to one embodiment of the present invention; and

FIG. 7 is a side view of a modified head of a diesel engine according to one embodiment of the present invention.

### DETAILED DESCRIPTION OF THE INVENTION

Preferred embodiments of the present invention are illustrated in the FIGURES, like numerals being used to refer to like and corresponding parts of the various drawings. The particular values and configurations discussed in these non-limiting examples, however, can be varied and are cited merely to illustrate an embodiment of the present invention and are not intended to limit the scope of the invention.

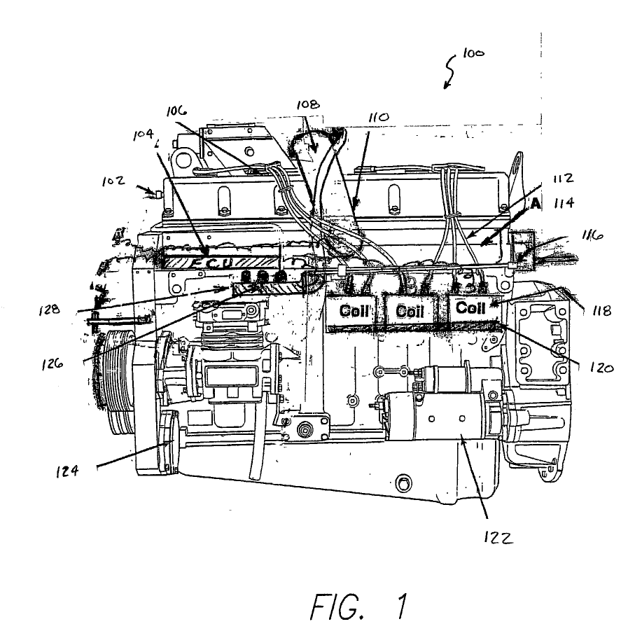

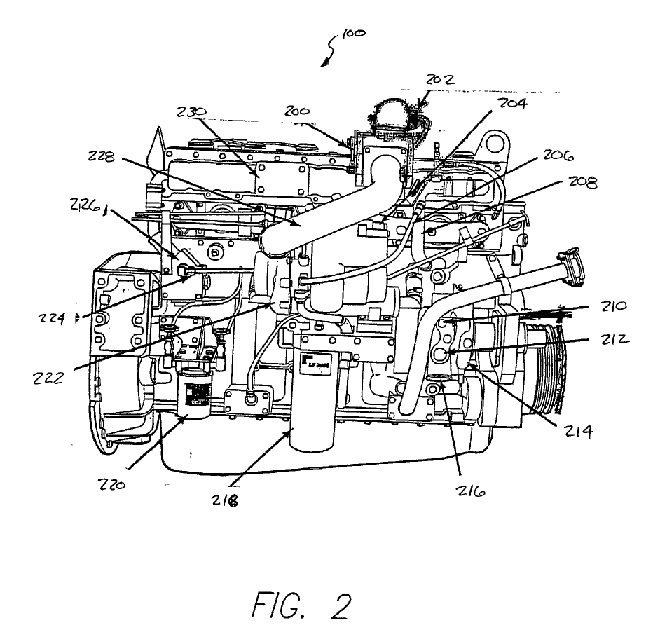

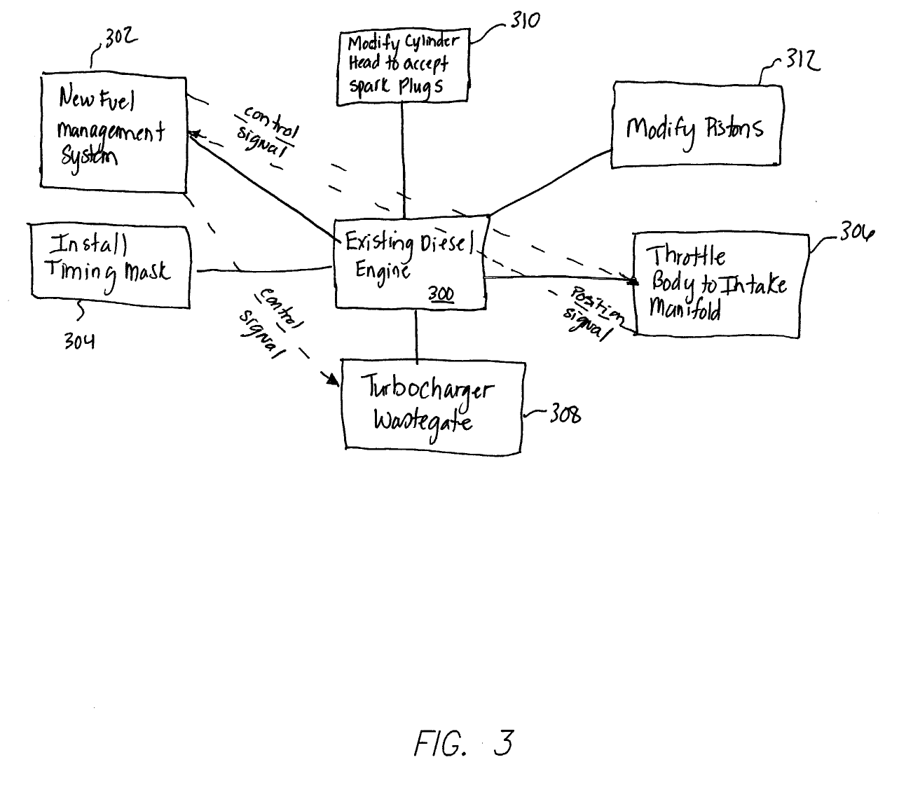

FIGS. 1 and 2 depict a modified engine according to one embodiment of the present invention, the table below references the major external engine components. Some external components will be at different locations for different engine models. The components of the modified diesel engine according to one embodiment of the present invention will be described in greater detail with reference to FIGS. 3 through 7 below.

[image]

[image]

[image]

[image]

As depicted in FIG. 3, according to one embodiment of the present invention, several modifications to a typical diesel engine 300 are performed to convert the diesel engine 300 to efficiently operate on natural gas fuels. These modifications include altering the fuel management system in block 302, installing a timing mask in block 304, adding a throttle body to the intake manifold of the diesel engine 300 in block 306, adding a turbocharger wastegate in block 308, installing spark plugs into the cylinder head in block 310, and modifying the pistons and piston ring configuration in block 312. Converting the diesel engine 300 to operate on natural gas requires that the fuel management system 302 be configured to the combustion characteristics of natural gas fuels. Differences in combustion and other thermodynamic characteristics of diesel and natural gas fuels dictate that the fuel management system 302 must be converted to be compatible with natural gas fuels. Constraints in a diesel fuel management system are incompatible with natural gas fuels because diesel engines 300 operate by compression ignition and natural gas engines operate by spark ignition. For example, air/fuel ratios and the timing of air/fuel delivery must be adjusted to optimize the performance of the converted engine.

In a preferred embodiment, an AFS Sparrow III Fuel Management System may be used as the fuel management system 302. The fuel management system 302 delivers the proper fuel mixture of natural gas in response to one or more sensors, which monitor engine performance, whereas a typical diesel engine may use a mechanical injection pump, which is inherently less efficient over a typical range of engine operating conditions. The fuel management system 302 also controls the air/fuel ratio to maintain emissions levels that comply with ULEV CARB/EPA standards. The air/fuel ratio may also be actively adjusted by the fuel management system 302 to deliver desired horsepower and torque. Additionally, the fuel management system 302 controls the waste gate of the turbocharger 308 to maximize engine performance.

One or more sensors may be used to monitor engine operation characteristics. The fuel management system 302 may monitor data from the sensors to determine engine performance and adjust the modified engine for optimal performance. One of the sensors monitors valve and piston positions in conjunction with a timing mask, which is installed in block 304. This particular sensor transmits piston and valve positions to the fuel management system 302. The timing mask may be mechanically or electrically connected to the to the crankshaft or a camshaft in the diesel engine 300. The fuel management system 302 uses data from this sensor to determine appropriate fuel mixture delivery and ignition requirements of the diesel engine 300.

The fuel management system 302 may also monitor exhaust gasses that pass through a catalytic converter, which may be located in an exhaust system. Typical diesel engines do not operate with a catalytic converter. A diesel engine modified to bum natural gas fuels may, however, be fitted with a three-way dual oxygen sensor catalytic converter downstream of the turbocharger/wastegate to control the final exhaust emissions to meet the ULEV CARB/EPA requirements. As a result, the fuel management system 302 may use data from oxygen sensors within the catalytic converter to adjust engine operating characteristics for optimized efficiency and reduced harmful emissions.

Other sensors that send data to the fuel management system 302 are associated with the throttle assembly, which is attached to the intake manifold in block 306. Although diesel engines do not have a throttle, spark ignition engines typically use a throttle to control engine speed. Adding the throttle assembly to the intake manifold of the diesel engine 300 allows an operator to control the amount of air/fuel mixture that is introduced into the cylinders. The throttle assembly incorporates an input sensor to send data related to the throttle position to the fuel management system 302. Additionally, the fuel management system 302 may operate an idle air control (IAC) on the throttle assembly to maintain efficient operation of the modified engine during idle speed.

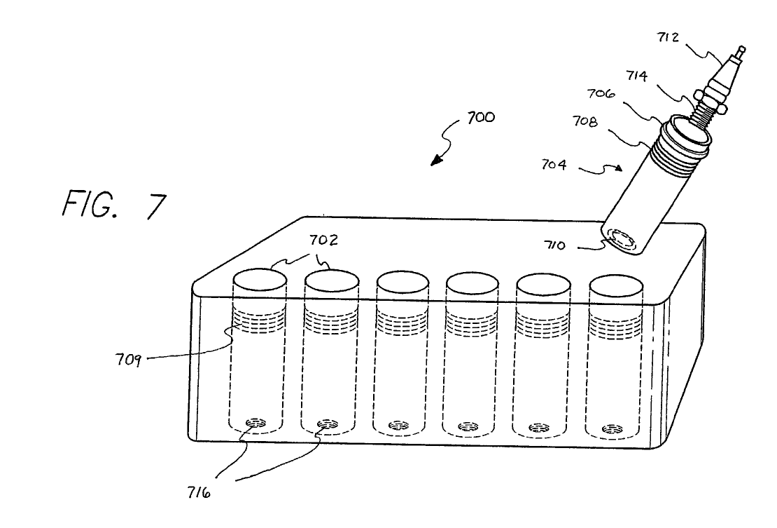

The fuel management system may also control a turbocharger wastegate, which is adapted to the diesel engine 300 in block 308. The turbocharger wastegate allows the fuel management system 302 to monitor and control the volume of exhaust gas that drives the turbocharger and thereby limit the boost pressure provided by the turbocharger. Excess exhaust gas may be diverted by the wastegate into the exhaust downstream of the turbocharger. Typical diesel engines do not have a turbocharger wastegate because the diesel fuel injector pump controls the horsepower/torque of the engine. The wastegate has been added to assist controlling the horsepower/torque of the natural gas-fueled engine. As depicted in block 310, the existing cylinder head on the diesel engine may be modified to operate on natural gas fuels. Modifications may include the addition of spark plugs and spark plug sleeves in place of diesel fuel injectors. Modifications to the diesel cylinder head will be described in greater detail below with reference to FIG. 7.

As depicted in block 312, the pistons of the diesel engine may be modified to efficiently operate with a natural gas fuel rather than diesel fuel. Diesel engine pistons are typically designed to exert high compression on the combustion chamber of the diesel engine. This design characteristic causes compression ignition. When converted to operate on natural gas fuels, however, a lower compression piston is desirable to prevent inefficient compression ignition of the natural gas fuel. For example, a typical diesel engine operates at a much higher compression ratio of 17.5 to 1 compared to a natural gas engine that may operate at a compression ratio of 10.5 to 1.

The top surfaces of the diesel engine pistons may be machined to reduce the overall compression in the engine cylinders. In one embodiment of the present invention, a generally concave depression may be machined into the top of the pistons to increase the overall volume of the combustion chambers when a particular piston is at top dead center (TDC). Modifying the shape of the piston also provides for more complete and efficient burning of the natural gas fuel, which reduces harmful emissions and increases the fuel efficiency of the modified engine. Other efficient piston top designs will be apparent to those having ordinary skill in the art of engine building.

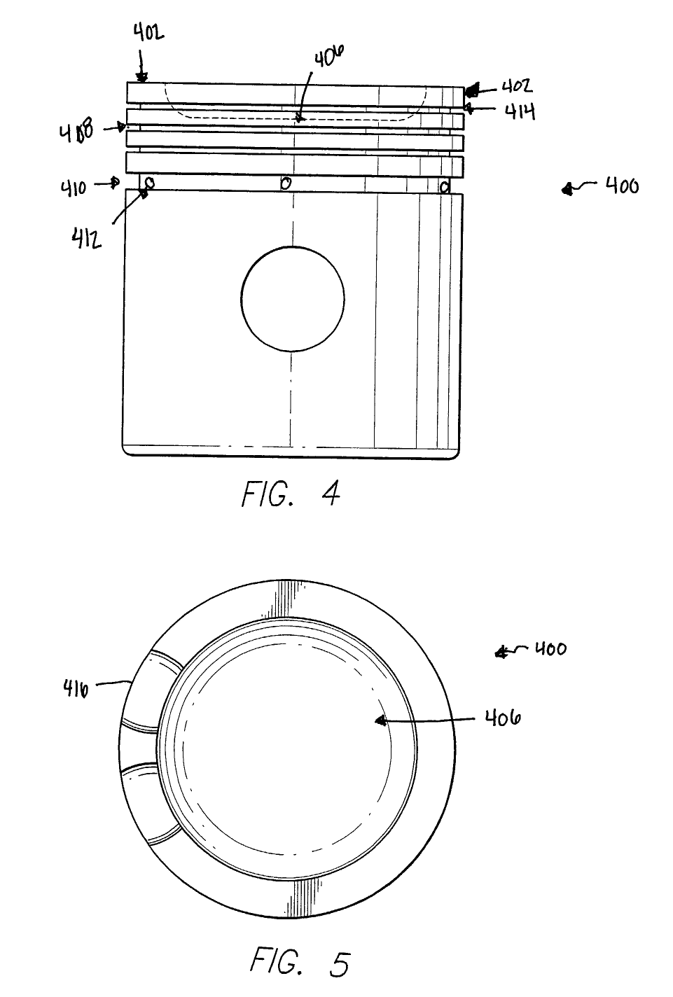

The pistons of the diesel engine may also be modified to incorporate additional piston rings to improve operating efficiency and reduce harmful emissions. Modifications to the pistons will be described in greater detail below with reference to FIGS. 4-6.

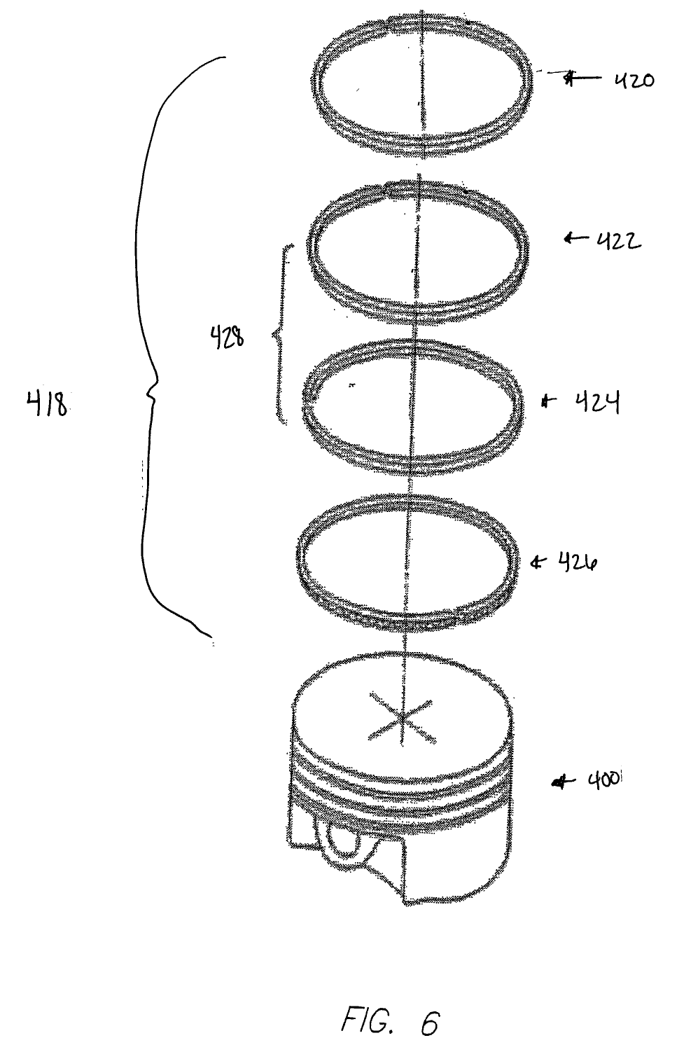

FIGS. 4, 5 and 6 depict a modified piston 400 and its corresponding piston rings (shown in FIG. 6) according to one embodiment of the present invention. The piston 400 is preferably constructed of an aluminum alloy or the like. As best shown in FIG. 4, the piston 400 comprises a top portion 402 having a top surface 404 whose middle portion is removed to form a dished or concave top 406 allowing for the reduction of the compression ratio, preferably four grooves 408 in the form of elongated channels proximate the top portion of the piston 402, the bottom groove 410 having a plurality of perforations 412 allowing oil to return into the crank case. Each piston grooves 410 is able to hold a piston ring (shown in FIG. 6). Of the piston ring grooves, the top ring groove 414, tends to have abrasion on its inner surface, because of the reasons that the temperature is high due to its close position to the combustion chamber.

As best shown in FIG. 5, a portion of the piston top surface 404 is recessed 416 for the clearance of the intake and exhaust valves.

As best shown in FIG. 6, the piston rings 418 include a top scraper ring 420, a top compression ring 422, a bottom compression ring 424, and an oil control ring 426. The top scraper ring 420, sitting at the top of the piston 400 means the top scraper ring 420 itself must be made of a more heat resistant material, than that typically used for top compression rings in today's engines as the top scraper ring 420 on many engines today run at close to 600° F., while the compression rings and oil control ring see temperatures of 300° F. or less. For applications where an engine is subjected to higher loads and operating temperatures, Molybdenum or Chrome faced rings usually provide the best wear resistance. Molybdenum provides scuff resistance and is porous, so it retains oil to keep the ring lubricated. Chrome also provides improved scuff resistance over the typical cast iron piston rings and is a good choice for engines that are operated in dusty environments because chrome is very dense and will not trap and hold contaminants like Molybdenum can.

Preferably the top scraper ring 420 allows the ring to glide over the cylinder wall during the piston downstroke. When the piston reverses direction, the sharp edge of the top scraper ring 420 is forced out against the wall and acts like a squeegee to wipe off the excess oil.

The top compression ring 422 is the first barrier to gas pressures passing down the sidewall of the piston. As the engine is displaced toward a top dead center or a minimum volume, the pressure in the cylinder keeps the top compression ring 422 seated against the lower wall of its ring groove in order to seal the combustion chamber. The second or lower compression ring 424 below the top ring 422 then shares some of the large pressure differential. The lower oil control ring 426 scrapes excessive amounts of oil downwardly along the cylinder wall as the piston 400 travels downwardly from the top of its stroke that was splashed or otherwise deposited relatively high on the cylinder wall when the piston was previously at or near the upper end of its upward stroke. It is recognized, of course, that the oil ring should permit enough lubricant to remain on the cylinder wall to sufficiently lubricate the one or more compression rings 428. The essential function of an oil control ring 426, then, is not to scrape all of the oil from the cylinder wall, but to meter lubricant to the compression rings 428 by permitting a thin, uniform, consistent film of oil to be retained along the cylinder wall.

FIG. 7 depicts a modified head 700 of a diesel engine according to one embodiment of the present invention. The head 700 has one or more injector orifices 702, which may typically house diesel fuel injectors and water jackets in an unmodified engine. The injector orifices 702 are modified to accept one or more sleeves 704. The sleeves 704 are typically cylindrical to fit within the injector orifices 702. The sleeves 704 may be manufactured from a material that has a similar coefficient of thermal expansion to that of the head 700. Similar coefficients of thermal expansion help to maintain desired tolerances between the head 700 and the sleeves 704 through the wide range of thermal cycles that the engine may endure.

One or more seals 706 about the circumference of the sleeves 704 prevent engine coolant from flowing into the injector orifices 702 or flowing from the head 700. The seals 706 may be o-rings or other sealing devices known to those having ordinary skill in the art of engine building. The seals 706 may also be located within grooves (not shown) on the sleeves 704 to enhance the sealing characteristics of the sleeves 704 and the seals 706.

The sleeves 704 may have sleeve threads 708 to removably fasten the sleeves 704 to mating threads 709 machined into the injector orifices 702. Threading the sleeves 704 into the injector orifices 702 may improve the sealing characteristics of the sleeves 704. Additionally, threading the sleeves 704 to the injector orifices 702 creates a more robust conversion system. Other methods of removably attaching the sleeves 704 to the head 700 may be utilized and will be apparent to those having ordinary skill in the art of engine building.

For example, the lower ends of the sleeves 704 have plug openings 710 to allow the end of a spark plug 712 to be inserted into a combustion chamber of the engine. Plug threads 714 engage mating threads in a plughole 716, which is machined into the lower end of the injector orifice 702. The sleeves 704 may alternatively be removably fastened to the head 700 if the diameter of the plug opening 710 is smaller than the diameter of the plug 712. The outer diameter of the plug 712 may engage the shoulder of the plug opening 710 to hold the sleeve 704 in place within the injector orifice 702.

The procedure to convert the head 700 from diesel to natural gas operation according to one embodiment of the present invention includes: 1) modifying the head 700 to accept the sleeves 704; 2) modifying the head 700 to accept the spark plugs 712; and 3) installing the sleeves 704 and spark plugs 712 into the head 700. This procedure may be accomplished by first removing any diesel fuel injectors and water jackets from the head 700. Second, threads 709 may be machined into the injector orifices 702 using conventional machining techniques. The plughole 716 may then be re-sized and re-threaded to accept a desired spark plug 712. Re-sizing and re-threading may also be accomplished using conventional machining techniques. Finally, the sleeves 704 and plugs 712 may be installed into the head 700. The completed head 700 is then ready for installation onto the modified engine.

The embodiments and examples set forth herein are presented to best explain the present invention and its practical application and to thereby enable those skilled in the art to make and utilize the invention. Those skilled in the art, however, will recognize that the forgoing description and examples have been presented for the purpose of illustration and example only. Other variations and modifications of the present invention will be apparent to those of skill in the art. The description as set forth is not intended to be exhaustive to limit the scope of the invention. It is contemplated that the use of the present invention can involve components having different characteristics.

What is claimed is:

1. A kit for converting a compression ignition diesel engine into a spark ignition natural gas engine, the kit comprising:
a throttle body;
a fuel management system;
a timing module;
a means for reducing a compression ratio of a piston in the diesel engine;
a means for providing a spark in a cylinder of the natural gas engine.

2. The kit of claim 1, further comprising a turbocharger wastegate.

3. The kit of claim 1, further comprising one or more spark plug sleeves to replace one or more diesel injector sleeves in the diesel engine.

4. The kit of claim 1, wherein the throttle body is adapted to deliver a fuel mixture to an existing intake manifold on the diesel engine.

5. The kit of claim 1, wherein the fuel management system monitors one or more natural gas engine parameters and adjusts natural gas engine performance according to the one or more natural gas engine parameters.

6. The kit of claim 1, wherein the timing module monitors the position of one or more camshafts and provides camshaft position information to the fuel management system.

7. The kit of claim 1, wherein the means for reducing a compression ratio of a piston in the diesel engine is by machining the top of the piston.

8. The kit of claim 1, wherein the means for providing a spark in a cylinder of the natural gas engine is by a spark plug.

9. The kit of claim 1, wherein the means for providing a spark in a cylinder of the natural gas engine is by modifying a cylinder head of the diesel engine to accept a spark plug.

10. A method for converting a compression ignition diesel engine into a spark ignition natural gas engine, the method comprising the steps of:
providing a diesel engine;
machining one or more cylinder heads on the diesel engine to accept one or more spark plugs, the one or more spark plugs located in the one or more cylinder heads to ignite a air/fuel mixture in one or more combustion chambers of the diesel engine;
machining a top surface of one or more pistons of the diesel engine to increase the volume of the one or more combustion chambers when the one or more pistons are located at top dead center (TDC) in the diesel engine;
providing a fuel management system to deliver the air/fuel mixture to the one or more combustion chambers; and
providing a timing module to monitor the position of one or more camshafts on the diesel engine and provide piston position information to the fuel management system.

11. The method of claim 10, further comprising the step of machining the one or more cylinder heads to accept one or more spark plug sleeves, the one or more spark plug sleeves replacing one or more diesel injector sleeves in the diesel engine.

12. The method of claim 10, further comprising the step of providing a turbocharger wastegate in an exhaust stream of the natural gas engine to regulate exhaust gas delivered to a turbocharger on the natural gas engine.

13. The method of claim 10, further comprising the step of providing a catalytic converter downstream of the turbocharger and turbocharger wastegate.

14. The method of claim 10, wherein the one or more pistons have at least four piston rings to reduce oil pass-by into the one or more combustion chambers.

15. The method of claim 10, wherein the fuel management system monitors data from one or more sensors on the natural gas engine and uses the data to adjust operation of the natural gas engine.

16. The method of claim 10, further comprising the step of providing a throttle body to deliver the air/fuel mixture into an intake manifold of the diesel engine.

17. The method of claim 10, further comprising the step of providing one or more ignition coils electrically connected to the one or more spark plugs.

18. The method of claim 10, wherein the step of machining a top surface of one or more pistons of the diesel engine is machining a generally concave depression into the top surface of the one or more pistons of the diesel engine.
